(19) United States
(12) Patent Application Publication
(10) Pub. No.: US 2006/0143477 A1
(43) Pub. Date: Jun. 29, 2006

(54) User identification and data fingerprinting/authentication

(76) Inventor: Harden E. Stevens III, Lexington, SC (US)

Correspondence Address: John D. Cowart;NCR Corporation, 1700 South Patterson Blvd., Dayton, OH, 45479-0001, US

(21) Appl. No.: 11/023,941

(22) Filed: Dec. 27, 2004

(51) Int. Cl. H04L 9/00; G06F 12/14; H04K 1/00; H04L 9/32; G06F 11/30

(52) U.S. Cl. 713/193; 713/182; 713/176; 713/181

(57) ABSTRACT

A user identification and file fingerprinting/authentication system for identifying a user, and fingerprinting and authenticating at least one file. The system includes a network server, a database, a user identification block, and a file fingerprinting block. The database includes contact information of a plurality of users including the user. The user identification block receives a user identifier from the user that indicates a desire to fingerprint the file for later authentication. The user identification block provides the user identifier to the database to receive contact information of the user. The user identification block operates to generate and transmit a key identifier to the user using the contact information of the user. The file fingerprinting block to allow the user to upload the at least one file upon verification of the key identifier by the file fingerprinting block. The file fingerprinting block operates to generate characteristic information about the at least one file and to fingerprint the file. The file fingerprinting block includes a digital fingerprint generator that produces a digital fingerprint of the file.

### BACKGROUND

A typical data security technique secures data by encrypting and restricting access to the data. This may involve encrypting the data using the public key of a private/public key pair and/or providing a password for accessing the data. The data may then be recovered by decrypting the data using the private key of the private/public key pair and/or supplying the password.

However, the above-described technique often cannot prevent or recognize illegitimate alterations or replications of data by an authorized user. Thus, in some cases, the technique may prevent unauthorized users from gaining access to the data but the technique may not prevent authorized users from altering or replicating the data. For example, using the conventional technique it may be very difficult to prevent an authorized user from altering or replicating the data to make it appear as though the data has not been altered or replicated.

### SUMMARY

In one implementation, a user identification and file fingerprinting/authentication system for identifying a user, and fingerprinting and authenticating at least one file is disclosed. The system includes a network server, a database, a user identification block, and a file fingerprinting block. The database includes contact information of a plurality of users including the user. The user identification block receives a user identifier from the user that indicates a desire to fingerprint the file for later authentication. The user identification block provides the user identifier to the database to receive contact information of the user. The user identification block operates to generate and transmit a key identifier to the user using the contact information of the user. The file fingerprinting block to allow the user to upload the at least one file upon verification of the key identifier by the file fingerprinting block. The file fingerprinting block operates to generate characteristic information about the at least one file and to fingerprint the file. The file fingerprinting block includes a digital fingerprint generator that produces a digital fingerprint of the file.

In a further implementation, a method for identifying a user, and fingerprinting and authenticating at least one file is disclosed. The method includes receiving a user identifier from the user that indicates a desire to fingerprint said at least one file for later authentication; retrieving contact information of the user using the user identifier; and generating and transmitting a key identifier to the user using the contact information of the user. The method also includes allowing uploading and storing of said at least one file upon verification of the key identifier; generating characteristic information about said at least one file and fingerprinting said at least one file; and producing a digital fingerprint of said at least one file.

In a further implementation, a computer program, stored in a tangible storage medium, for identifying a user, and fingerprinting and authenticating at least one file is disclosed. The program comprises executable instructions that cause a computer to: receive a user identifier from the user that indicates a desire to fingerprint said at least one file for later authentication; retrieve contact information of the user using the user identifier; allow uploading and storing of said at least one file upon verification of the key identifier; generate characteristic information about said at least one file and fingerprinting said at least one file; and produce a digital fingerprint of said at least one file.

### BRIEF DESCRIPTION OF THE DRAWINGS

FIG. 1 is a block diagram of a user identification/file fingerprinting system in accordance with one implementation.

FIG. 2 is a block diagram of the user identification/file fingerprinting system in accordance with another implementation.

FIG. 3 shows a detailed functional block diagram of a file fingerprinting process in accordance with one implementation.

FIG. 4 shows a functional block diagram of a file authentication system in accordance with one implementation

FIG. 5 is a method for fingerprinting a file so that data in the file can be authenticated later.

FIG. 6 is a method for authenticating a file using the digital fingerprint generated and stored in the encryption process.

### DETAILED DESCRIPTION

This disclosure describes systems and methods that provide user identification/file fingerprinting and file authentication. Various implementations of the user identification/file fingerprinting and file authentication are described.

Further, the terms “public key” and “private key”, as used in the discussions below, refer to a specific type of encryption and decryption method and apparatus, and therefore, do not necessarily indicate that they are either “public” or “private” in terms of whether or not the keys are made available to the public in general. Furthermore, the term public/private as used to describe a type of cryptography, can refer to any type of asymmetric cryptographic technique. Additionally, the “public key” and “private key” are interchangeable in the sense that the “public key” can be used to encrypt data while using the “private key” to decrypt the data or the “private key” can be used to encrypt data while using the “public key” to decrypt the data.

In particular, the user identification/file fingerprinting and file authentication systems are not based on restricting access to data but is based on allowing the authorized user to enter data into a data file and then locking the data file to prevent alterations or illegitimate replications. This can be done by initially identifying the user, and fingerprinting the file when the user has been identified. The data file can then be authenticated at some later time.

The user identification process involves verifying the identity of the user through the use of secure information and allowing the user to submit at least one file for fingerprinting. Once the user has been identified, the submitted file(s) can be fingerprinted by uniquely identifying and storing the file(s). The file fingerprinting process involves generating certain characteristics that are unique to each file, producing a public/private key pair and then encrypting the characteristics of the file(s) using one of the key pair. In one implementation, the characteristics that are unique to each submitted file include information about the file, such as the date of creation of the file, the date of last update of the file, the file length, the file address, the date the file was fingerprinted, and other related information. Once the encryption is completed, the key used to encrypt the characteristics of the file(s) is destroyed. The encrypted characteristics and the remaining key from the key pair are stored.

In one implementation, file authentication involves using the remaining key to decrypt the encrypted characteristics of the file(s). However, without the destroyed key, the encrypted characteristics cannot be altered. The submitted file(s) is not encrypted but is stored in the original form. Authentication of a submitted file may be performed at a later time and can be accomplished by: regenerating the certain characteristics unique to the submitted file; retrieving the stored encrypted characteristics and the remaining key; decrypting the encrypted characteristics using the remaining key; comparing the newly regenerated characteristics to the decrypted characteristics; and if all characteristics match, then reporting the file as having been authenticated. Otherwise, if any of the characteristics fail to match, then reporting the file as not having been authenticated. Any alteration to the originally submitted file (submitted for fingerprinting) or its characteristics will cause the authentication of the file to fail. This assures that not only the contents of the file are unaltered but also other related characteristics such as the date the file was submitted for fingerprinting are unaltered.

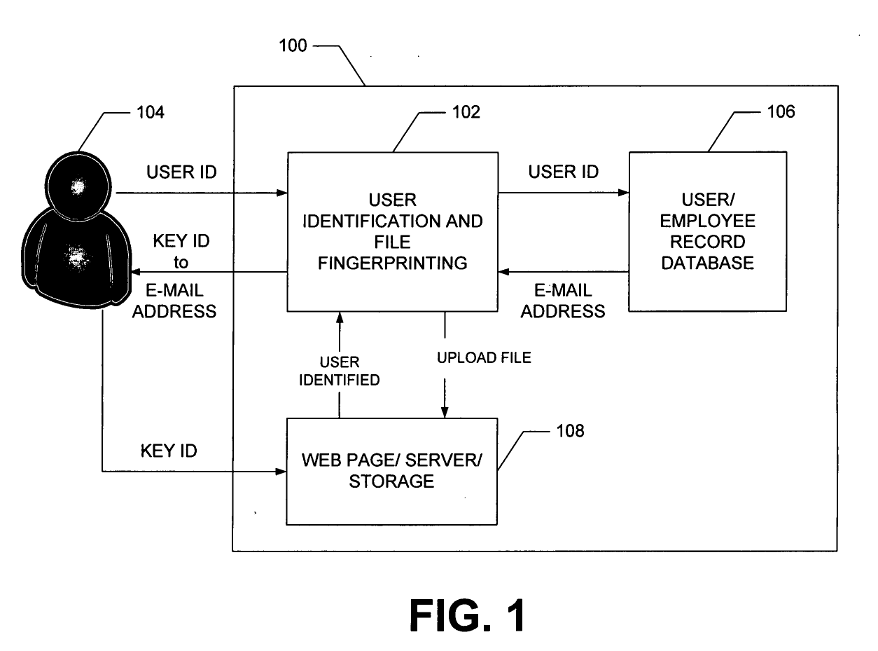

FIG. 1 shows one implementation of a user identification/file fingerprinting system 100, which includes a user identification and file fingerprinting block 102, a user/employee record database 106, and a web page/server/storage 108. The user identification/file fingerprinting system 100 is configured to operate in two modes, a user identification mode and a file fingerprinting mode.

In the user identification mode, the system 100 operates to identify the user. In the file fingerprinting mode, the system 100 operates to generate certain characteristics that are unique to each file of at least one file submitted by the user. In one implementation, the user/employee record database 106 is a Teradata Active Data Warehousing System available from NCR Corporation.

When the user 104 desires to submit at least one file for fingerprinting, the user logs onto the system 100 by entering a user identifier (USER ID), such as an employee number, a login identifier, or other related identifiers. In another implementation, the system 100 can uniquely identify the user 104 by identifying the computer/device that the user uses to log onto the system 100.

In the illustrated implementation of FIG. 1, the user identification and file fingerprinting block 102 receives the user identifier entered by the user 104. The block 102 uses the user identifier to search the user/employee record database 106 for user's personal information, which can be used to contact the user 104. The personal information includes user's telephone number, e-mail address, login password, or other related contact information. Since the user contact information is retrieved from a secure record database, only an authenticated user will be able to submit the file for fingerprinting.

In the illustrated implementation, the user identification and file fingerprinting block 102 retrieves an e-mail address of the user from the record database 106 and generates a key identifier associated with the user identifier. Since an authorized user/employee should be the only person with access to the e-mail account, if the user 104 who submitted the original user identifier to the system 100 is the authorized user/employee, the original user 104 will receive the key identifier through the e-mail. The user 104 receives the key identifier and submits the key identifier to the web page/server/storage 108 presented by the system 100. The system 100 then either confirms or rejects the identity of the user 104 based on the submitted key identifier. Once the identity of the user 104 has been authenticated, the system 100 enters the file fingerprinting mode in which at least one file submitted by the user is fingerprinted. In some implementations, the web page/server/storage 108 can be configured as any server connected to a network.

In one implementation, the user identification and file fingerprinting block 102 uploads and stores one or more files onto the web page/server/storage 108. The user 104 enters information about file(s), which the user will submit. The user 104 then prepares and submits/uploads one or more files onto the web page/server/storage 108 using the key identifier. For both implementations, the user identification/file fingerprinting block 102 then generates a fingerprint of the uploaded file(s).

The fingerprinting process involves the user identification and file fingerprinting block 102 generating characteristics that are unique to the user submitted/uploaded file and producing a public/private encryption key pair, which will be used to encrypt the unique file characteristics and later for decrypting the unique file characteristics during the file authentication process. The public/private encryption key pair can be generated using a conventional public/private encryption technique, such as the Rivest-Shamir-Adleman (RSA) technique, which is based on the assumption that it is easy to multiply two prime numbers, but difficult to divide the result again into the two prime numbers. However, the public/private encryption key pair can be generated using any asymmetric one-way public/private encryption technique. The fingerprinting process is described in detail below.

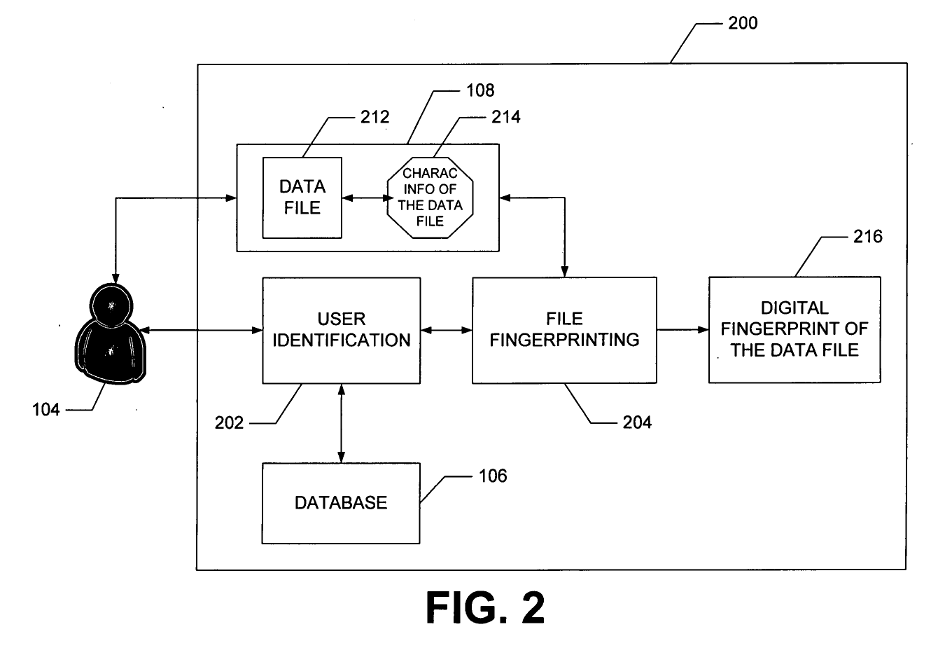

FIG. 2 is a block diagram of the user identification/file fingerprinting system 200 in accordance with another implementation. The user identification/file fingerprinting system 200 includes a user identification block 202 and a file fingerprinting block 204. Further, the user identification/file fingerprinting system 200 interfaces with a data file 212 and characteristic information about the data file 214 in the web page/server/storage 108, and the database 106 to produce a digital fingerprint 216 of the data file 212. In one implementation, the fingerprint 216 of the data file 212 is generated by encrypting the characteristic information about the data file 214.

When the user 104 desires to submit at least one file for fingerprinting, the user transmits the user identifier to the user identification block 202. The block 202 receives the user identifier entered by the user 104, and uses the user identifier to search the database 106 for user's personal information, such as an e-mail address. The block 202 retrieves the e-mail address of the user from the database 106 and informs the file fingerprinting block 204 that the user has been identified. The block 202 also generates a key identifier and transmits it to the e-mail address of the user 104, who submits the key identifier to the web page/server/storage 108 to initiate the file fingerprinting process.

When the file fingerprinting process is initiated, the file fingerprinting block 204 uploads and stores one or more files onto the web page/server/storage 108. The user 104 enters information about file(s) the user will submit, and uploads the file(s) 212. Once the user 104 completes the uploading of the file(s) 212, the file fingerprinting block 204 operates to produce a digital fingerprint of the file 216, which involves generating characteristic information 214 about the uploaded file(s). As mentioned above, the characteristic information 214 about the uploaded file(s) includes information such as the date of creation of the uploaded file, the date of last update of the file, the file length, the file address, the fingerprinting date, and other related information.

In some implementations, the characteristic information 214 about the uploaded file is included in an information file. In other implementations, the characteristic information may be a loose grouping of digital units or may be included as packet data in a data stream.

Although the illustrated implementation only shows one set of data file and characteristic information, a plurality of sets of data files and characteristic information can be fingerprinted by the user identification/file fingerprinting system 200.

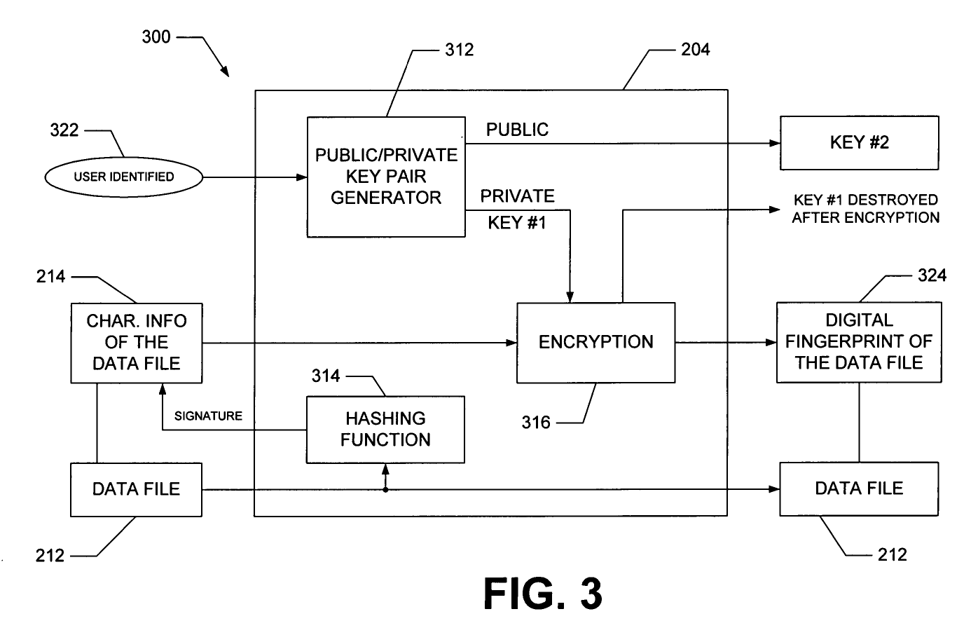

FIG. 3 shows a detailed functional block diagram of a file fingerprinting process 300 in accordance with one implementation. The file fingerprinting process 300 includes a file fingerprinting block 204, which includes a public/private key pair generator 312, a hashing function 314, and an encryption block 316. The file fingerprinting block 204 receives a user identified signal 322 and generates a pair public/private key; and receives characteristic information 214 about a data file 212 and generates a digital fingerprint 324 of the data file.

When the file fingerprinting block 204 receives a signal 322 that the user has been identified, the public/private key pair generator 312 generates a pair of keys, a public key and a private key. In FIG. 3, the private key is labeled as KEY #1 and the public key is labeled as KEY #2. However, in other implementations, KEY #1 could be the public key and KEY #2 could be the private key.

The hashing function 314 of the file fingerprinting block 204 receives and performs one-way hash on the contents of the data file 212 to produce one of the characteristics of characteristic information 214. In one implementation, Secure Hashing Algorithm (SHA-1) can be used to produce a relatively short signature key. The hash signature along with other file characteristics constitute the characteristic information 214 of the data file 212. The hashing function does not alter the data file but rather generates a unique signature based on the current setting of each bit in the data file 212. Changing even a single bit in the data file 212 causes the hashing function to produce a different signature thus identifying that the data file 212 has been changed.

The encryption block 316 encrypts the characteristic information 214 with KEY #1 to generate a digital fingerprint 314 of the data file 212. Thus, encrypting the characteristic information 214 about the data file 212 produces the digital fingerprint of the data file 212. Once the encryption is completed, the file fingerprinting process 300 stores the data file 212, the digital fingerprint 324, and KEY #2 in a storage unit such as the web page/server/storage 108.

KEY #1 is destroyed to prevent alteration or illegitimate replication of the characteristic information 214 about the data file 212. In most fingerprinting/authentication process, a complete documentation of the destruction of KEY #1 should be sufficient to prove that there was no alteration or illegitimate replication of the characteristic information.

The above-described processing by the encryption block 316 is performed on the characteristic information 214 rather than on the data file 212 directly. This allows the data file to be viewed without having to decrypt the file. Furthermore, encrypting the relatively smaller-sized characteristic information is more efficient than having to encrypt the larger-sized data file. However, in some implementations, the encryption process can be performed on the data file.

As described above, the authentication process involves regenerating characteristic information of the data file, retrieving the stored encrypted characteristic information and the remaining key, and decrypting the encrypted characteristic information using the remaining key. Since any change made to the data file changes the characteristic information of the data file, the authentication of the data file can be performed by comparing the newly regenerated characteristic information to the decrypted characteristic information. If all characteristic information matches, then the file has been authenticated. Otherwise, if any of the characteristic information fails to match, then the data file fails the authentication.

Although the characteristic information of the data file can be recovered/decrypted using a second key (i.e., one of public/private keys that was not used to encrypt the characteristic information), the characteristic information cannot practically be altered or illegitimately replicated because the first key used to encrypt the characteristic information has been destroyed. It would not be practically possible to recreate or guess the first key.

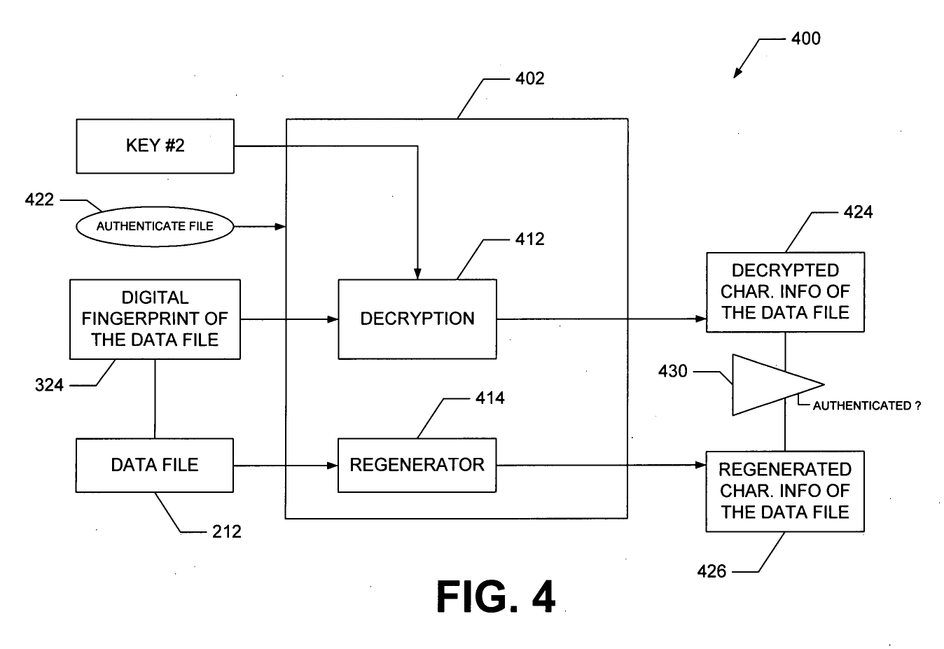

FIG. 4 shows a functional block diagram of a file authentication system 400 in accordance with one implementation. The file authentication system 400 includes a data authentication block 402, which includes a decryption block 412 and a regenerator 414. Inputs to the authentication block 402 include a signal to initiate file authentication 422, KEY #2, the digital fingerprint 324 of the data file 212, and the data file 212.

When the signal to initiate file authentication 422 is received at the authentication block 402, the decryption block 412 retrieves the stored digital fingerprint of the data file 324 and decrypts the encrypted fingerprint using KEY #2 to produce the decrypted characteristic information 424 of the data file 212. Further, the regenerator 414 processes the data file 212 and regenerates the characteristic information 426 of the data file 212. Therefore, the regeneration process involves processing the data file 212 and regenerating the current characteristic information about the data file 212, such as the date of creation of the file, the date of last update of the file, the file length, the file address, the date the file was fingerprinted and other related information.

A comparator 430 compares the newly regenerated characteristic information 426 to the decrypted characteristic information 424. If all characteristic information identically matches, then the data file 212 has been authenticated. Otherwise, if any of the characteristic information fails to identically match, then the data file 212 fails the authentication. As mentioned above, the characteristic information includes information, such as the date of creation of the data file, the date of last update of the data file, the data file length, the data file address, the user's identification, the date the file was fingerprinted and other related information. When a file is authenticated, not only are the contents of the file authenticated but the date the file was uploaded and fingerprinted is also authenticated. When more than one data file needs to be authenticated, the above-described process can be repeated.

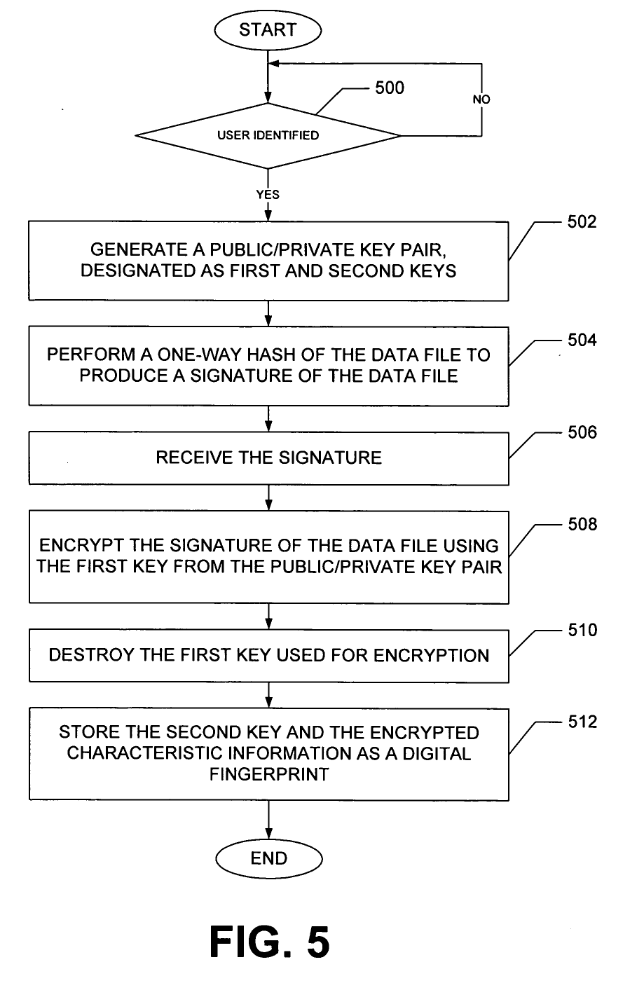

FIG. 5 is a method for fingerprinting a file so that data in the file can be authenticated later. The method is illustrated as a flowchart and is described below.

In the illustrated implementation, a determination is made, at 500, whether the user has been identified. Once the user has been identified, a public/private key pair, designated as a first key and a second key, is generated, at 502. One of the keys of the key pair is sent to a user using the user contact information such as a user's email address. The user copies and submits the key to a web page. The submitted key is then compared to one of keys of the key pair and either authenticates the user and continues the process or fails to authenticate the user and terminates the process.

At 504, a one-way hash of the contents of the data file is performed to produce a signature of the data file. The purpose of the one-way hash function is to create a unique signature of the data in the data file. Additional methods and functions that create a unique signature of a data file can be used. The signature of the data file (i.e., the characteristic information) is received, at 506, and is encrypted, at 508, using the first key from the public/private key pair. In one implementation, the first key is the private key. In another implementation, the first key is the public key.

Once the encryption is finished, the first key used to encrypt the characteristic information of the file is destroyed, at 510, to prevent alteration or illegitimate replication of the characteristic information. The second key and the encrypted characteristic information of the file are stored, at 512.

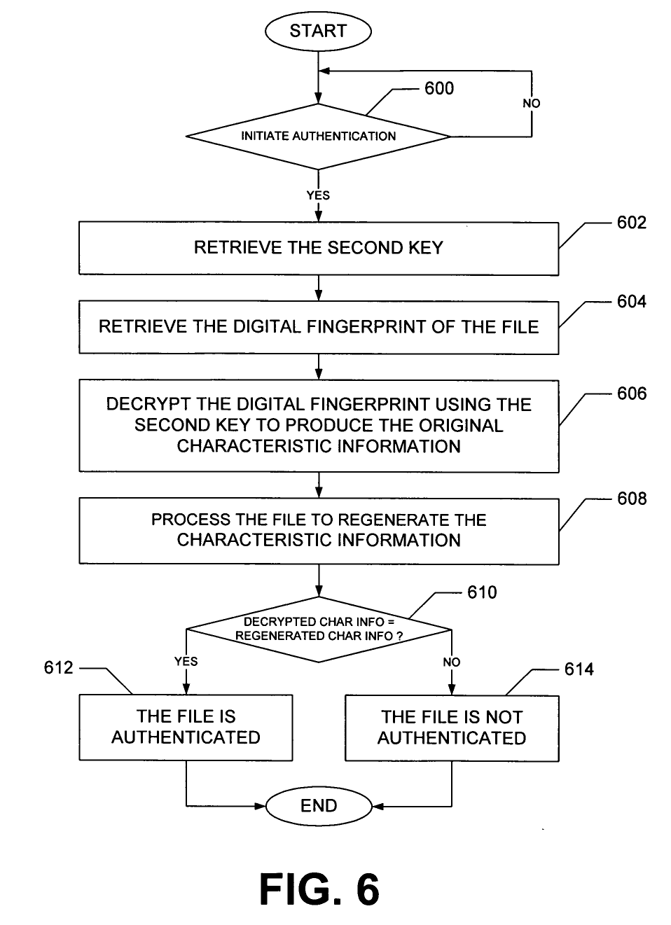

FIG. 6 is a method for authenticating a file using the digital fingerprint generated and stored in the encryption process. The method is illustrated as a flowchart and is described below.

In the illustrated implementation, a determination is made, at 600, whether an indication has been received to initiate an authentication process. Once the indication has been received, the second key of the public/private key pair is retrieved, at 602. At 604, the digital fingerprint of the file is retrieved. The retrieved digital fingerprint of the file is then decrypted, at 606, using the second key of the public/private key pair to produce the original characteristic information of the file. Further, at 608, the file is processed to regenerate characteristic information of the file.

Once the decryption and the regeneration are completed, the regenerated characteristic information is compared to the decrypted characteristic information, at 610. Since the decrypted characteristic information of the file in the fingerprint had been secured by discarding of the key that was used to encrypt the characteristic information, and since any changes to the file would be reflected in the regenerated characteristic information of the file, if the decrypted characteristic information and the regenerated characteristic information match, it can be substantially assumed that no changes have been made to the file or to the characteristic information about the file. Therefore, if it is determined, at 610, that the decrypted characteristic information and the regenerated characteristic information match, the file is declared as having been authenticated, at 612. Otherwise, if it is determined, at 610, that the decrypted characteristic information and the regenerated characteristic information do not match, the file is declared as not authenticated, at 614.

Various implementations of the invention are realized in electronic hardware, computer software, or combinations of these technologies. Most implementations include one or more computer programs executed by a programmable computer. For example, in one implementation, the system for identifying a user, and fingerprinting and authenticating at least one file includes one or more computers executing software implementing the user identification, file fingerprinting, and file authentication process discussed above. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Although various illustrative implementations of the present invention have been described, one of ordinary skill in the art will see that additional implementations are also possible and within the scope of the present invention.

Accordingly, the present invention is not limited to only those implementations described above.

What is claimed is:

1. A user identification and file fingerprinting/authentication system for identifying a user, and fingerprinting and authenticating at least one file, comprising:
a network server;
a database that includes contact information of a plurality of users including the user;
a user identification block to receive a user identifier from the user that indicates a desire to fingerprint said at least one file for later authentication, said user identification block providing the user identifier to the database to receive contact information of the user, said user identification block operating to generate and transmit a key identifier to the user using the contact information of the user; and
a file fingerprinting block to allow the user to upload said at least one file upon verification of the key identifier by the file fingerprinting block, said file fingerprinting block operating to generate characteristic information about said at least one file and to fingerprint said at least one file,
said file fingerprinting block including
a digital fingerprint generator that produces a digital fingerprint of said at least one file.

2. The system of claim 1, wherein said digital fingerprint generator includes:
a public/private key pair generator to generate first and second keys;
a hashing function to generate a unique digital signature of said at least one file, wherein said digital signature constitutes one of the characteristic information; and
an encryption block to encrypt the characteristic information with the first key, and output a digital fingerprint of said at least one file,
wherein the first key is destroyed after the encryption to prevent alteration or illegitimate replication of the characteristic information.

3. The system of claim 2, wherein said first key is a private key and said second key is a public key.

4. The system of claim 2, wherein said first key is a public key and said second key is a private key.

5. The system of claim 2, further comprising
a data authentication block to provide authentication of said at least one file.

6. The system of claim 5, wherein said data authentication block includes
a decryption block to decrypt the digital fingerprint of said at least one file using the second key.

7. A method for identifying a user, and fingerprinting and authenticating at least one file, comprising:
receiving a user identifier from the user that indicates a desire to fingerprint said at least one file for later authentication;
retrieving contact information of the user using the user identifier;
generating and transmitting a key identifier to the user using the contact information of the user;
allowing uploading and storing of said at least one file upon verification of the key identifier;
generating characteristic information about said at least one file and fingerprinting said at least one file; and
producing a digital fingerprint of said at least one file.

8. The method of claim 7, wherein said producing a digital fingerprint of said at least one file includes:
generating first and second keys;
producing a unique digital signature of said at least one file by performing a hash function on the data file, wherein said digital signature constitutes one of the characteristic information;
encrypting the characteristic information with the first key; and
outputting a digital fingerprint of said at least one file.

9. The method of claim 8, further comprising
destroying the first key after the encryption to prevent alteration or illegitimate replication of the characteristic information.

10. The method of claim 9, further comprising
decrypting the digital fingerprint of said at least one file using the second key to determine the characteristic information of said at least one file.

11. The method of claim 10, further comprising
processing said at least one file to regenerate the characteristic information of said at least one file.

12. The method of claim 11, further comprising:
comparing the decrypted characteristic information of said at least one file to the regenerated characteristic information of said at least one file.

13. The method of claim 12, further comprising
declaring said at least one file as having been authenticated when the comparison indicates that the decrypted characteristic information of said at least one file identically matches the regenerated characteristic information of said at least one file.

14. The method of claim 12, further comprising
declaring said at least one file as not having been authenticated when the comparison indicates that the decrypted characteristic information of said at least one file does not identically match the regenerated characteristic information of said at least one file.

15. A computer program, stored in a tangible storage medium, for identifying a user, and fingerprinting and authenticating at least one file, the program comprising executable instructions that cause a computer to:
receive a user identifier from the user that indicates a desire to fingerprint said at least one file for later authentication;
retrieve contact information of the user using the user identifier;
generate and transmit a key identifier to the user using the contact information of the user;
allow uploading and storing of said at least one file upon verification of the key identifier;
generate characteristic information about said at least one file and fingerprinting said at least one file; and
produce a digital fingerprint of said at least one file.

16. The computer program of claim 15, wherein said producing a digital fingerprint of said at least one file includes executable instructions that cause a computer to:
generate first and second keys;
produce a unique digital signature of said at least one file by performing a hash function on the data file, wherein said digital signature constitutes one of the characteristic information;
encrypt the characteristic information with the first key; and
output a digital fingerprint of said at least one file.

17. The computer program of claim 16, further comprising executable instructions that cause a computer to:
destroy the first key after the encryption to prevent alteration or illegitimate replication of the characteristic information.

18. The computer program of claim 16, further comprising executable instructions that cause a computer to:
decrypt the digital fingerprint of said at least one file using the second key to determine the characteristic information of said at least one file.

19. The computer program of claim 18, further comprising executable instructions that cause a computer to:
process said at least one file to regenerate the characteristic information of said at least one file.

20. The computer program of claim 19, further comprising executable instructions that cause a computer to:
compare the decrypted characteristic information of said at least one file to the regenerated characteristic information of said at least one file.

21. The computer program of claim 20, further comprising executable instructions that cause a computer to:
declare said at least one file as having been authenticated when the comparison indicates that the decrypted characteristic information of said at least one file identically matches the regenerated characteristic information of said at least one file.

22. The computer program of claim 20, further comprising executable instructions that cause a computer to:
declare said at least one file as not having been authenticated when the comparison indicates that the decrypted characteristic information of said at least one file does not identically match the regenerated characteristic information of said at least one file.
